(19) United States
(12) Patent Application Publication
(10) Pub. No.: US 2026/0131579 A1
(43) Pub. Date: May 14, 2026

(54) RECORDING APPARATUS, RECORDING METHOD, AND STORAGE MEDIUM

(71) Applicant: CANON KABUSHIKI KAISHA, Tokyo (JP)

(72) Inventor: TAKETOSHI KUSAKABE, Kanagawa (JP)

(21) Appl. No.: 19/370,843

(22) Filed: Oct. 28, 2025

(30) Foreign Application Priority Data
Nov. 11, 2024 (JP) 2024-196515

(51) Int. Cl. B41J 11/00; B41J 11/66; B41J 29/20

(52) U.S. Cl. CPC B41J 11/0095; B41J 11/007; B41J 11/66; B41J 29/20

(57) ABSTRACT

A recording apparatus includes: a conveying part configured to convey a continuous sheet; a recording part configured to perform recording on the continuous sheet during the conveyance; a detection part configured to detect a splice of the continuous sheet; and a control part configured to control the recording part and the conveying part based on the detection result. In case of detection of the splice during the recording, the control part performs control to record, on the continuous sheet, information related to a discarded region of the continuous sheet. This information includes at least one of: in image data being recorded by the recording part, information on a portion that has been recorded; information on a portion where the recording has been suspended in response to the detection of the splice; and information on a portion where the recording has been resumed after the suspension.

### BACKGROUND

### Field of the Technology

The present disclosure relates to a recording apparatus and a recording method for recording on a continuous sheet fed from a roll, and a storage medium storing a program for performing the recording.

### DESCRIPTION OF THE RELATED ART

In a recording apparatus for recording on a continuous sheet fed from a roll, splice processing is performed to connect the leading and trailing edges of continuous sheets using a splice tape. The splice processing is performed, for example, to connect the trailing edge of a continuous sheet remaining in the recording apparatus after replacing a roll to the leading edge of a continuous sheet fed from a new roll, or to connect continuous sheets resulting from cutting off an unnecessary portion, for example, to clear a jam. A splice, which is a connecting portion created by the splice processing, is not used as a deliverable and is discarded. A splice, when passing through a conveyance roller during a recording operation, may cause disruption in the conveyance. Furthermore, when a recording head is in a recording position, there is a possibility that a splice may collide with the recording head because the splice is thicker than the normal portion. Therefore, a continuous sheet is conveyed until a splice reaches a wind-up device, and then a recording operation is performed. Regions in front and rear of the splice, which are conveyed for paper discharge for the splice, are not used as a deliverable and serve as discarded regions (waste paper regions). The continuous sheet after recording (deliverable) is wound up by the wind-up device. In a post-process following the process of recording for the deliverable, processing of cutting the continuous sheet at a predetermined cutting position and processing of skipping the discarded regions are performed while conveying (paper feeding) a roll formed by winding the deliverable.

Japanese Patent Application Publication No. 2021-144620 describes that a printing management device transmits post-process information such as a cutting position to a post-process device via a printing control device.

The technology described in Japanese Patent Application Publication No. 2021-144620 is based on the premise that the post-process device is connected to the printing management device via a network or the like. Therefore, when a post-process device that is not connected to the printing management device is used, the post-process device cannot acquire post-process information such as a cutting position. In this case, an operator needs to visually check the post-process device to press a paper feed button to skip the discarded regions, resulting in reduced efficiency of the post-process processing.

### SUMMARY

The present disclosure enables transmission of post-process information to a post-process device or an operator in a post-process.

According to one aspect of the present disclosure, a recording apparatus includes: a conveying part that conveys configured to convey a continuous sheet in a conveyance direction; a recording part that performs configured to perform recording on the continuous sheet while the continuous sheet is being conveyed during the conveyance of the continuous sheet in a conveyance direction by the conveying part; a detection part that detects configured to detect a splice that is a connecting portion of the continuous sheet; and a control part that controls configured to control the recording part and the conveying part based on a detection result from the detection part. In a case where the detection part detects the splice during the recording by the recording part, the control part performs control to record, on the continuous sheet, information related to a discarded region that is a region of the continuous sheet, the region including the detected splice and not used as a deliverable. The information related to the discarded region includes at least one of: in image data to be being recorded by the recording part, information on a recorded portion that has been recorded; information on a portion where the recording was has been suspended in response to the detection of the splice; and information on a portion where the recording has been resumed after the suspension suspended in response to the detection of the splice was resumed.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a recording system according to an embodiment.

FIG. 2 is a block diagram illustrating functions of the recording system according to the embodiment.

FIGS. 3A to 3G are diagrams illustrating results of recording on a continuous sheet including splices. FIG. 3A illustrates the continuous sheet with two splices. FIGS. 3B to 3F illustrate the time series of conveyance of a continuous sheet and recording on the continuous sheet. FIG. 3G illustrates the state where recording of six pages on the continuous sheet is completed.

FIGS. 4A to 4E are diagrams illustrating examples of information related to discarded regions. FIGS. 4A and 4B indicate the contents of discarded region start information. FIGS. 4C and 4D indicate the contents of discarded region end information. FIG. 4E indicates the contents of discarded region statistical information.

FIG. 5 is a flow chart illustrating control of the recording system.

### DESCRIPTION OF THE EMBODIMENTS

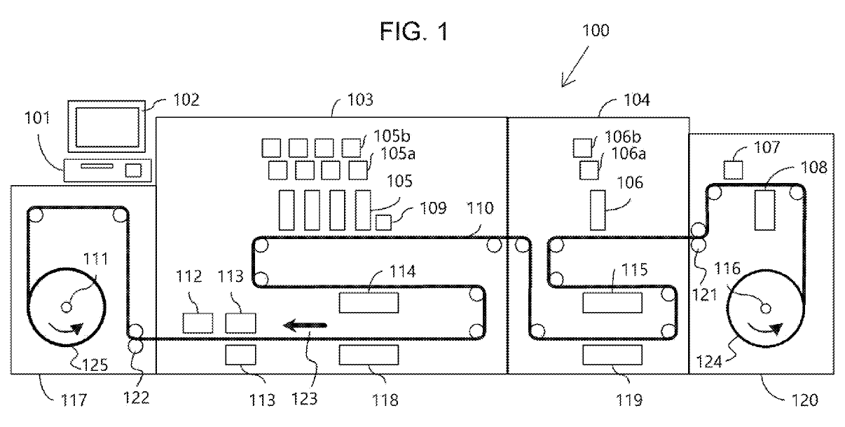

Hereinafter, exemplary embodiments for carrying out the present disclosure will be described with reference to the drawings. However, the dimensions, materials, shapes, relative arrangement and the like of the components described in the following examples may be modified as appropriate depending on the configuration and various conditions of the device to which the present disclosure is applied, and are not intended to limit the scope of the present disclosure to the following examples.

[First Embodiment] FIG. 1 is a diagram illustrating a configuration of a recording system according to a first embodiment. The recording system 100 is a device that records images on a continuous sheet (continuous paper, roll paper) 110 that allows continuous recording (printing, image formation). The recording system 100 includes a control apparatus 101, an operation display 102, a paper feed apparatus 120, a paper discharge apparatus 117, a first recording apparatus 103, and a second recording apparatus 104.

The control apparatus 101 is a computer that controls the operation of the recording system 100.

The operation display 102 has an operation section, including buttons or a touch panel, that allows a user to input commands and information to the recording system 100, and a display section, including a display, that displays the state of the recording system 100.

The paper feed apparatus 120 is a paper feed part that feeds, from a roll 124 formed by winding the continuous sheet 110 in a roll shape, the continuous sheet 110 to the first recording apparatus 103 and the second recording apparatus 104. The paper feed apparatus 120 rotates a paper tube around a rotation shaft 116 and pulls out the continuous sheet 110 wound on the paper tube from the roll 124. The paper feed apparatus 120 conveys the continuous sheet 110 via a plurality of rollers including a conveyance roller pair 121 toward the first recording apparatus 103 at a constant speed.

The paper feed apparatus 120 includes a skew correction device 108 and a splice detector 107. The skew correction device 108 is a device that corrects skew of the continuous sheet 110. The splice detector 107 detects a splice in the continuous sheet 110.

The splice is a connecting portion where the ends (trailing and leading edges) of the continuous sheet 110 are connected to each other by a splice tape. The recording system 100 performs control not to perform recording on the splice. The splice detector 107 is a detection part that detects a splice, which is a connecting portion of the continuous sheet 110. The splice detector 107 detects the thickness of the continuous sheet 110 using a transmission type ultrasonic sensor, and when a portion that is thicker than the front and rear portions is found, determines the portion as a splice. Note that the method by which the splice detector 107 detects a splice is not limited to this, and a configuration can be applied such that a splice can be detected by another method such as image analysis using a CCD camera or differential detection of surface attributes using a reflection sensor.

The paper discharge apparatus 117 is a paper discharge part that winds up the continuous sheet 110, which has been conveyed through the first recording apparatus 103 and the second recording apparatus 104, into a roll 125 around a paper tube. The paper discharge apparatus 117 rotates around a rotation axis 111, and winds the conveyed continuous sheet 110 as a deliverable into a roll at a constant speed via a plurality of rollers including a conveyance roller pair 122.

The first recording apparatus 103 has a plurality of first recording heads 105 (print heads) that eject basic color ink (e.g., Y (yellow), M (magenta), C (cyan), and K (black)) onto the continuous sheet 110, and records the basic colors onto the continuous sheet 110. The first recording heads 105 record characters, images, or the like on the continuous sheet 110 which is a sheet-like recording medium such as paper. Each of the first recording heads 105 has a large number of nozzles, and ejects ink from these nozzles onto the continuous sheet 110 to record, for example, an image of a predetermined pattern. The first recording apparatus 103 includes a drying device 114, a cooling device 118, a scanner device 113, a color measurement device 112, and a timing mark detection device 109.

The scanner device 113 reads a pattern for inspecting ink ejection defects recorded on the continuous sheet 110 to check whether or not there are any ink ejection defects in a recorded image.

The color measurement device 112 reads a pattern for measuring color recorded on the continuous sheet 110. The color measurement device 112 is movable in a conveyance direction of the continuous sheet 110 and in a direction perpendicular to the conveyance direction, and is capable of measuring the color of not only the image on the continuous sheet 110 but also any location. The color measurement device 112 is capable of measuring the color of a region that is a square region of the continuous sheet 110 having a size of 1 cm or more in length and width and is recorded in the same color.

The second recording apparatus 104 has a second recording head 106 (print head) that ejects special color ink (e.g., ink other than basic color ink such as white ink and fixing primer ink) onto the continuous sheet 110, and records the special color onto the continuous sheet 110. The second recording head 106 records characters, images, and a recording base onto the continuous sheet 110, which is a sheet-like recording medium such as paper. The second recording head 106 has a large number of nozzles, and ejects ink from these nozzles onto the continuous sheet 110 to record, for example, a base of a predetermined pattern. The second recording apparatus 104 includes a drying device 115 and a cooling device 119.

The recording system 100 includes the conveyance roller pair 121 and the conveyance roller pair 122, which are conveying part that convey the continuous sheet 110. The conveyance roller pair 121 and the conveyance roller pair 122 each convey the continuous sheet 110 by rotating with the continuous sheet 110 sandwiched between nip portions of the two rollers. The conveyance roller pair 121 and the conveyance roller pair 122 convey the continuous sheet 110 in the conveyance direction indicated by an arrow 123 by rotating forward, and convey the continuous sheet 110 in the direction opposite to the direction indicated by the arrow 123 by rotating in the reverse direction.

Before starting recording, the user does a work of passing the continuous sheet 110 from the paper feed apparatus 120 to the paper discharge apparatus 117. The user sets a roll in the paper feed apparatus 120, pulls out the continuous sheet 110 therefrom, and passes the leading edge of the continuous sheet 110 over the skew correction device 108. The user then passes the continuous sheet 110 under the splice detector 107 and under the second recording head 106 of the second recording apparatus 104. Subsequently, the user passes the continuous sheet 110 over the drying device 115 and over the cooling device 119. The user passes the continuous sheet 110 under the timing mark detection device 109 of the first recording apparatus 103, under the first recording heads 105, over the drying device 114, and over the cooling device 118. The user passes the continuous sheet 110 through the scanner device 113 and under the color measurement device 112, and winds the continuous sheet 110 in the paper discharge apparatus 117.

After passing the continuous sheet 110 through the recording system 100, the user submits an image formation job to the control apparatus 101 of the recording system 100. After submitting the image formation job, the user presses a recording start button on the operation display 102 to cause the recording system 100 to start recording.

The first recording heads 105 and the second recording head 106 eject ink onto the continuous sheet 110 to form an image. The first recording heads 105 and the second recording head 106 form a recording part that performs recording on the continuous sheet 110 while the conveying part conveys the continuous sheet 110 in the conveyance direction indicated by the arrow 123. The first recording apparatus 103 has the plurality of first recording heads 105 respectively corresponding to a plurality of ink colors (Y, M, C, K).

The first recording head 105 for each color is supplied with ink from a buffer tank 105a for each color, and the buffer tank 105a for each color is supplied with ink from a tank 105b for each color. The second recording head 106 is supplied with ink from a buffer tank 106a, and the buffer tank 106a is supplied with ink from a tank 106b. The user does a work of replacing each of the tanks 105b and 106b. When replacing each of the tanks 105b and 106b, the user opens the lid of the corresponding location, and after the tank replacement is complete, closes the lid to complete the replacement work. The lid has a locking mechanism that prevents replacement outside of the permitted times for replacement.

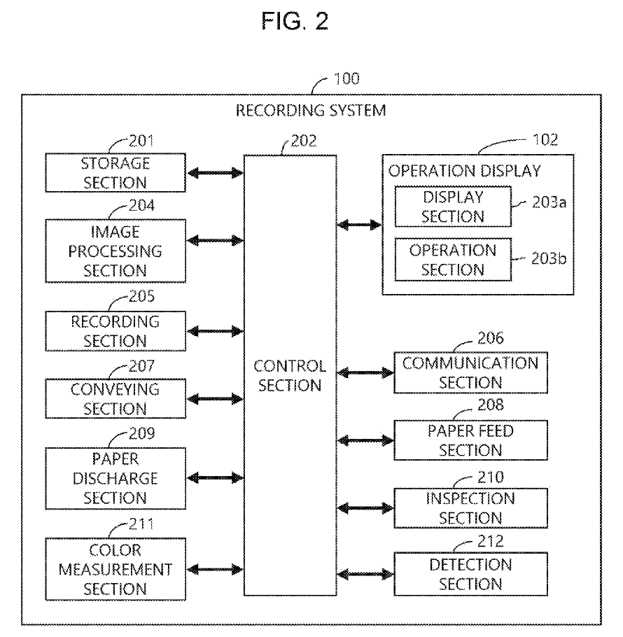

FIG. 2 is a block diagram illustrating functions of the recording system according to the first embodiment. The recording system 100 includes a storage section 201, a control section 202, the operation display 102, an image processing section 204, a recording section 205, a communication section 206, a conveying section 207, a paper feed section 208, a paper discharge section 209, an inspection section 210, and a color measurement section 211.

The storage section 201 is configured with a non-volatile semiconductor memory (flash memory), a hard disk drive (HDD), a solid state drive (SSD), or the like. The storage section 201 stores therein various programs such as system programs and processing programs executed by the control section 202, and various types of data required in executing such programs.

The control section 202 includes a central processing unit (CPU), a random access memory (RAM), and so on. The CPU in the control section 202 reads various programs such as the system programs and processing programs stored in the storage section 201, and loads the programs onto the RAM, and executes various types of processing in accordance with the programs thus loaded. For example, the control section 202 can perform image formation processing (recording processing) for executing an image formation job (hereinafter, referred to as a job) in response to an instruction from the user. Each of the functions that configure the recording system 100 is controlled on the basis of instructions from the control section 202.

The operation display 102 is configured with, for example, a liquid crystal display (LCD) with a touch panel, and includes a display section 203a and an operation section 203b. The display section 203a displays various types of information on a display screen in accordance with a display control signal input from the control section 202. The operation section 203b includes various operation keys such as a numeric keypad and a start key, and receives various input operations from the user and outputs operation signals to the control section 202. By operating the operation section 203b, the user can optionally set recording conditions such as the type of paper to be used, printing speed, number of prints, number of copies to be printed, and print length. The display section 203a can also display the remaining amount of ink in each of the buffer tanks 105a and 106a, the remaining amount of roll in the paper feed apparatus 120, and the free roll capacity of the paper discharge apparatus 117, as well as information on whether or not replenishment work is required.

The image processing section 204 performs image processing, such as analysis processing, rendering processing, and screen processing, on image data specified as a recording target, and converts the resulting data into a format that can be recorded by the recording system 100.

The recording section 205 controls the recording of an image on the continuous sheet 110 by the first recording heads 105 and the second recording head 106.

The communication section 206 is a communication part configured with a communication control card such as a local area network (LAN) card or the like. The communication section 206 transmits and receives various types of data to and from an external device (e.g., a personal computer) connected to a communication network such as a LAN or a wide area network (WAN).

The conveying section 207 controls the conveyance mechanism for the continuous sheet 110 inside of the recording system 100. The conveying section 207 conveys the continuous sheet 110 fed from the paper feed apparatus 120 by the conveyance roller pairs 121 and 122 to the paper discharge apparatus 117 via the first recording heads 105 and the second recording head 106.

The paper feed section 208 controls the paper feed apparatus 120. The paper discharge section 209 controls the paper discharge apparatus 117.

The inspection section 210 controls the scanner device 113 to check whether recording has been performed on the continuous sheet 110 without any ink ejection defects. When the scanner device 113 detects an ink ejection defect, the recording operation of the recording system 100 is stopped. The inspection method is not limited to this, and various other methods are available, such as a method of recording an inspection pattern and reading the inspection pattern with the scanner device 113, a method of directly reading and inspecting the recorded image using a camera or scanner, and a method of monitoring the conditions of ink ejections from the nozzles.

The color measurement section 211 measures the color of a location on the continuous sheet 110 specified by the control section 202 using the color measurement device 112 to obtain color information.

When the splice detector 107 detects a splice, the detection section 212 notifies the control section 202 of a splice-detected ON signal. When no splice is detected, the detection section 212 notifies the control section 202 of a splice-detected OFF signal.

The control section 202 controls the operations of the respective sections described above. In the first embodiment, the control section 202 is a control part that controlling the first recording heads 105, the second recording head 106 (recording section 205), and the conveyance roller pairs 121 and 122 (conveying section 207) based on a detection result from the splice detector 107 (detection section 212).

An operation for recording on a continuous sheet 110 without a splice in the recording system 100 will be described.

First, the user submits a job. Image data for the job is created in an external device, recording settings for the job are made, and the resulting pieces of information are transmitted to the recording system 100 via the communication network.

Next, the control section 202 of the recording system 100 receives, via the communication section 206, the image data of the job transmitted from the external device and a job ticket containing the recording setting information for the job, information on the number of turns to be delivered, and so on. The submission of the job is thus completed. The submitted job is processed by the image processing section 204. Specifically, the image processing section 204 extracts information from the job ticket and pixel data from the image data, and converts the pixel data into recording data that can be recorded by the first recording heads 105 and the second recording head 106 for each pixel position so as to obtain a deliverable (printed matter) that reflects the recording settings. This conversion processing includes processing of decomposed the pixel data into the plurality of ink colors to be ejected by the first recording heads 105.

When the recording of the submitted job starts, the continuous sheet 110 is conveyed along the path described with reference to FIG. 1. During the conveying process, the continuous sheet 110 passes under the splice detector 107. When a splice is detected here, the control section 202 is notified of that, and when no splice is detected, no special control is performed. A case where no splice is detected will be described below.

Next, the control section 202 causes the recording section 205 to record a timing mark and a base on the continuous sheet 110 using the second recording head 106. As the continuous sheet 110 is conveyed, the timing mark and the base reach the timing mark detection device 109 via the drying device 115 and the cooling device 119. The control section 202 determines the timing to start recording based on the time at which the timing mark detection device 109 detects the timing mark, and starts recording using the first recording heads 105. When the continuous sheet 110 reaches the scanner device 113, the control section 202 causes the inspection section 210 to check whether or not there is an ink ejection defect. When the continuous sheet 110 reaches the color measurement device 112, the color measurement section 211 measures the color of a location on the continuous sheet 110 specified by the control section 202.

Finally, the continuous sheet 110 is wound up in the paper discharge apparatus 117.

The control section 202 controls the supply of ink from the tanks 105b and 106b and the buffer tanks 105a and 106a to the first recording heads 105 and the second recording head 106. The control section 202 controls the mechanisms involved in replacing each of the tanks 105b and 106b, controls notifications by the operation display 102, and the like.

The splice detector 107 detects a splice upstream of the first recording heads 105 and the second recording head 106 in the conveyance direction. If a splice is present on the continuous sheet 110 between the splice detector 107 and the paper discharge apparatus 117, there is a possibility that conveyance will be disturbed when the splice passes through the conveyance roller pairs 121 and 122. Therefore, the recording system 100 controls the recording so that a region where conveyance accuracy may be reduced due to the presence of a splice is not used as a deliverable. Therefore, in the recording system 100, when the splice detector 107 detects a splice, a region including the detected splice on the continuous sheet 110 becomes a discarded region (waste paper region), which is a region is not to be used as a deliverable.

The recording system 100 is characterized in that, when the splice detector 107 detects a splice while the recording section 205 performs recording, the recording system 100 performs control to record information related to a discarded region on the continuous sheet 110.

The information related to the discarded region recorded on the continuous sheet 110 includes at least one of the following pieces of information:

Information on the start position of the discarded region in the conveyance direction

Information on the end position of the discarded region in the conveyance direction

Information on the length of the discarded region in the conveyance direction

Information on a recorded portion in image data to be recorded by the recording section 205

Information on a portion where recording was suspended in response to detection of a splice in image data to be recorded by the recording section 205

Information on a portion where recording suspended in response to detection of a splice in image data to be recorded by the recording section 205 was resumed

In the first embodiment, the control section 202 records information related to the discarded region on leading and trailing edge portions of a discarded region in the conveyance direction.

When the splice detector 107 detects a splice while the recording section 205 performs recording, the control section 202 performs control to record on the continuous sheet 110 statistical information about discarded regions that have occurred on the roll 124. After the recording of image data to be recorded by the recording section 205 has been completed, the control section 202 performs control to record the statistical information on the continuous sheet 110. The statistical information includes at least one of the following pieces of information:

Information on the length of the continuous sheet 110 that has been conveyed during a period from the start to the end of recording of image data to be recorded by the recording section 205

Information on the length of the continuous sheet 110 on which image data has been recorded

Information on the length of a discarded region that has occurred during a period from the start to the end of recording of image data

Information on the cumulative length of discarded regions that have occurred so far on the roll 124

The control section 202 records information related the discarded region(s) and the statistical information on the continuous sheet 110 in the form of characters or a code image. The code image is, for example, a barcode.

When a splice is present between the splice detector 107 and the paper discharge apparatus 117, the control section 202 performs control to stop the recording (ink ejection) by the recording section 205 and to continue only the conveyance of the continuous sheet 110. When the splice detector 107 detects a splice while the first recording heads 105 and the second recording head 106 perform recording, the control section 202 performs control to continue the conveyance of the continuous sheet 110 and to suspend the recording of the image data being recorded. Here, the reason for suspending only the recording (ink ejection) and continuing the conveyance is that if the conveyance is stopped, the recorded continuous sheet 110 will remain in the drying devices 114 and 115 and may be overheated.

After suspending the recording of the image data, the control section 202 records information related to a discarded region on the continuous sheet 110, and after recording the information on the discarded region on the continuous sheet 110, performs control to stop the recording by the recording section 205.

After suspending the recording of the image data, the control section 202 causes the conveying part (conveyance roller pairs 121 and 122) to convey the continuous sheet 110 by a predetermined conveyance amount. After conveying the continuous sheet 110 by the predetermined conveyance amount, the control section 202 performs control to continue the conveyance by the conveying part and to resume the recording of the image data. Here, the predetermined conveyance amount is determined on the basis of a conveyance amount required for the splice detected by splice detector 107 to reach the paper discharge apparatus 117. Specifically, the predetermined conveyance amount is the length of the conveyance path from the splice detector 107 to the paper discharge apparatus 117.

After causing the conveying part to convey the continuous sheet 110 by the predetermined conveyance amount, the control section 202 records information related to a discarded region on the continuous sheet 110. After recording the information related to the discarded region on the continuous sheet 110, the control section 202 performs control to resume the recording of the image data.

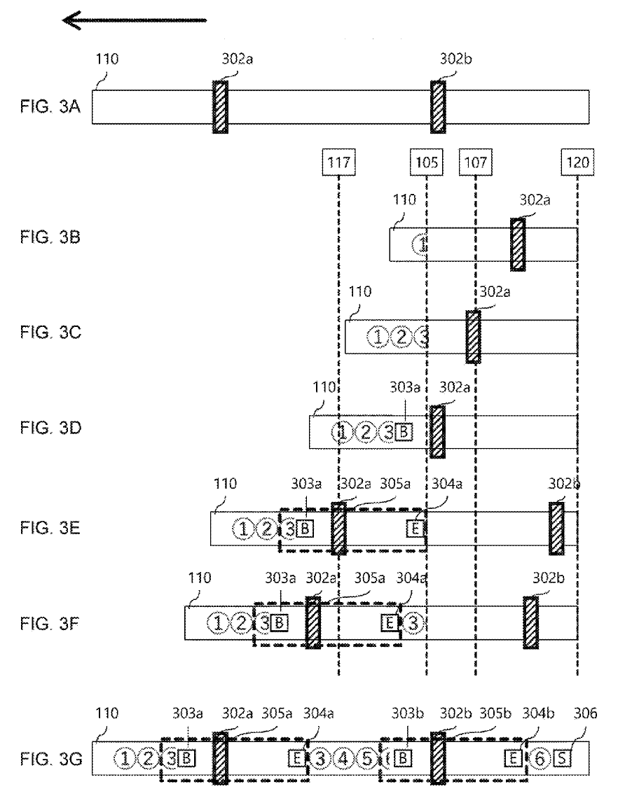

FIGS. 3A to 3G are diagrams illustrating, in chronological order, an example of recording results when the above-described recording system 100 records image data on a continuous sheet 110 including splices. FIGS. 3A to 3G illustrate an example in which image data of six pages is recorded. FIGS. 3A to 3G illustrate only the portion of the continuous sheet 110 relating to the recording of image data of six pages, but in reality, the continuous sheet 110 is continuous before and after the portion in the conveyance direction.

FIG. 3A illustrates that the continuous sheet 110 has splices 302a and 302b. The recording system 100 is unaware of the presence of a splice on the continuous sheet 110 until the splice is detected by the splice detector 107.

FIGS. 3B to 3F illustrate states of recording on and conveying the continuous sheet 110 in chronological order. In each figure, the right side is the upstream side in the conveyance direction of the continuous sheet 110. Each figure illustrates the positional relationship between the continuous sheet 110 being conveyed, the paper feed apparatus 120, the splice detector 107, the first recording heads 105, and the paper discharge apparatus 117. An example will be described below in which image data of six pages is recorded. In each figure, the circled numbers 1 to 6 indicate the page numbers. The length of each page in the conveyance direction is 1 m.

FIG. 3B illustrates the state at the start of recording the first page. It is a state where upon starting recording, the continuous sheet 110 is fed from the paper feed apparatus 120, passes under the splice detector 107, and subsequently passes through the first recording heads 105, and recording of the first page is thus started. At this point, the splice detector 107 has not detected the splice 302a, and the control section 202 has not been notified. At this time, the splice 302a has been conveyed from the paper feed apparatus 120 but has not yet reached the splice detector 107. Therefore, the splice detector 107 notifies the control section 202 of a splice-detected OFF signal. Since the control section 202 is unaware of the presence of the splice 302a, the control section 202 continues the recording of the image data, resulting in the state illustrated in FIG. 3C.

FIG. 3C illustrates a state where the splice 302a has reached the splice detector 107. At this point, the first recording heads 105 have completed recording of the first two pages and is currently performing recording of the third page. In response to detection of the splice 302a, the splice detector 107 notifies the control section 202 of a splice-detected ON signal, and then notifies the control section 202 of a splice-detected OFF signal when the splice 302a passes through the splice detector 107. When the control section 202 detects that the splice 302a has passed through the splice detector 107, the control section 202 instructs the recording section 205 to stop the recording. The recording section 205 stops the ink ejection for recording the image data even during the recording of a page. In this example, the recording is stopped at the time when 0.6 m of the third page was recorded. The control section 202 stores in the storage section 201 information that two pages have been recorded and information on the conveyance length from the beginning of a region on the continuous sheet 110 related to recording of image data of six pages. The control section 202 continues the conveyance of the continuous sheet 110, resulting in the state illustrated in FIG. 3D.

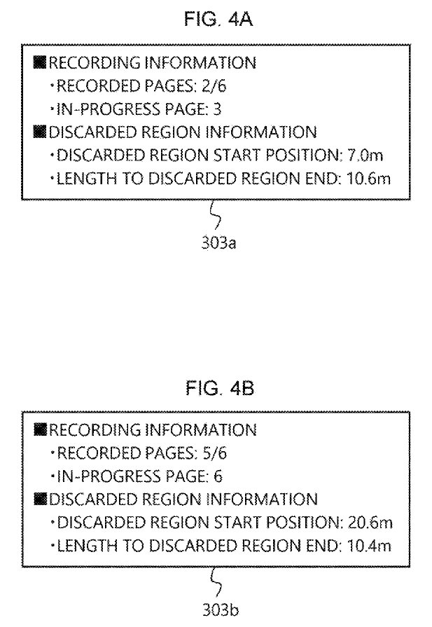

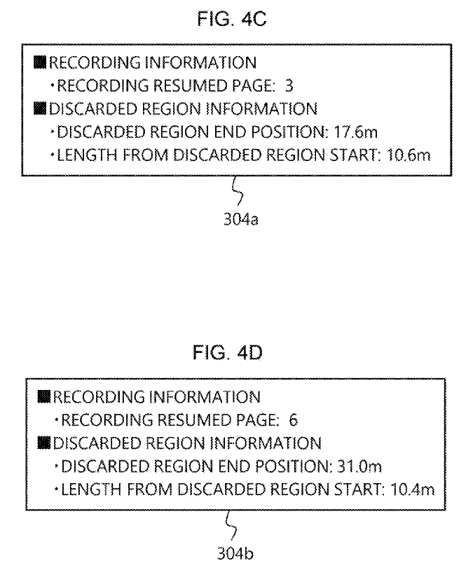

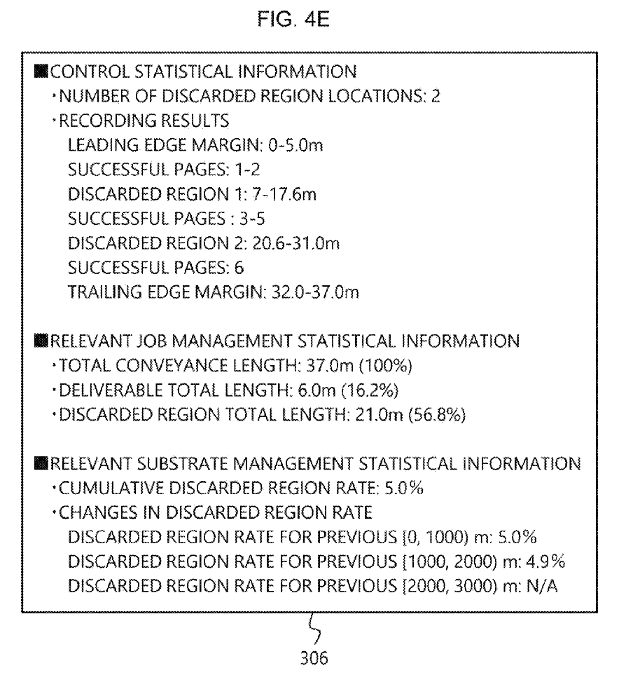

FIG. 3D is a diagram illustrating a state where discarded region start information 303a (waste paper start information) is recorded immediately after FIG. 3C. The discarded region start information 303a is an example of information related to a discarded region to be recorded on a leading edge portion of the discarded region. The discarded region start information 303a will be described in detail later with reference to FIGS. 4A to 4E. The control section 202 suspends the recording of the third page in the state illustrated in FIG. 3C, and generates the discarded region start information 303a based on the recording state and the conveyance state of the continuous sheet 110 at that time. The control section 202 performs control to record the discarded region start information 303a immediately after the suspended position on the third page. Thereafter, the control section 202 only performs the conveyance of the continuous sheet 110, resulting in the state illustrated in FIG. 3E.

FIG. 3E illustrates a state where discarded region end information 304a (waste paper end information) is recorded immediately before the splice 302a reaches the paper discharge apparatus 117, and immediately after that, the splice 302a reaches the paper discharge apparatus 117. The discarded region end information 304a is an example of information related to a discarded region to be recorded on a trailing edge portion of the discarded region. The discarded region end information 304a will be described in detail later with reference to FIGS. 4A to 4E. The control section 202 determines the timing to start recording the discarded region end information 304a based on a predetermined conveyance amount for the splice 302a to reach the paper discharge apparatus 117, a conveyance length of the continuous sheet 110 from FIG. 3C, and the size in the conveyance direction of the discarded region end information 304a. Specifically, the timing to start recording the discarded region end information 304a is determined such that the recording of the discarded region end information 304a ends at the time when the splice 302a reaches the paper discharge apparatus 117. In other words, the recording of the discarded region end information 304a starts at a time before the splice 302a reaches the paper discharge apparatus 117. The recording of the discarded region end information 304a may start after the splice 302a reaches the paper discharge apparatus 117. The predetermined conveyance amount is 10 m, which is the length of the conveyance path from the splice detector 107 to the paper discharge apparatus 117.

A discarded region 305a is a portion of the continuous sheet 110 that will not be used as a deliverable including the splice 302a detected after the start of recording the image data. In the example of FIG. 3E, the discarded region 305a is a region from the beginning of the third page, where recording was suspended, to the end of the discarded region end information 304a. The control section 202 resumes the suspended recording of the image data after completing the recording of the discarded region end information 304a and the splice 302a reaches the paper discharge apparatus 117. In this example, the control section 202 resumes the recording from the beginning of the third page, where recording was suspended in FIG. 3C. Specifically, the control section 202 acquires, from the storage section 201, information on the recorded portion of the image data to be recorded (in this example, information indicating that the page numbers 1 and 2 are the pages that have been recorded), and resumes the recording from the third page. As illustrated in FIG. 3E, at this point, the splice 302b has been conveyed from the paper feed apparatus 120 as the continuous sheet 110 is conveyed, but as in the state of FIG. 3B, the control section 202 is unaware of the presence of the splice 302b at this point.

FIG. 3F illustrates a state immediately before the recording of the fourth page is started after the recording operation resumed in FIG. 3E has completed the recording of the third page. The control section 202 is still unaware of the presence of the splice 302b at this point, but as the conveyance and recording of the continuous sheet 110 continues, the splice detector 107 detects the splice 302b after a certain period of time has elapsed. Thus, the control section 202 is aware of the splice 302b, and processing such as suspending the recording of the image data is performed in the same manner as in FIGS. 3C to 3E.

FIG. 3G illustrates a state where recording of six pages has been completed on the continuous sheet 110. In response to detection of the splice 302b, the same control as when the splice 302a is detected is performed. Then, recording of six pages is completed with discarded regions 305a and 305b present. As illustrated in FIG. 3G, the control section 202 performs control to record discarded region statistical information 306 (waste paper statistical information) at a position immediately after the recording of six pages has been completed. The discarded region statistical information 306 will be described in detail later with reference to FIGS. 4A to 4E. Here, an example is illustrated in which, in response to detection of the splice 302b, recording of the sixth page being recorded is suspended at the point where 0.4 m of the sixth page has been recorded. The length from the leading edge to the first page of a region of the continuous sheet 110 related to the recording of six pages of the image data, and the length from the trailing edge to the sixth page, are both 5 m.

The control section 202 performs control to record information related to a discarded region 305 (discarded region start information 303, discarded region end information 304, discarded region statistical information 306) on the continuous sheet 110 as a code image such as characters or a barcode. In post-process work, an operator can visually check the information related to the discarded region 305 recorded as characters on the continuous sheet 110 along with the deliverable pages, and thus obtain information necessary for the post-process, such as the cutting position(s) of the pages of the deliverable and the conveyance amount for feeding the discarded region. The information related to the discarded region 305 recorded on the continuous sheet 110 in the form of a code image can be read by a device capable of reading the code image, such as a barcode reader connected to a post-process device. The post-process device, which is not connected to the recording system 100, can thus obtain information necessary for the post-process. In this way, according to the recording system 100 of the first embodiment, it is possible to supply the information necessary for the post-process to the post-process device or an operator in the post-process.

FIGS. 4A to 4E are diagrams illustrating examples of information related to discarded regions to be recorded on the continuous sheet 110. These are created by the control section 202 using data stored in the storage section 201, and will be recorded on the continuous sheet 110 via the recording section 205.

FIG. 4A indicates the content of discarded region start information 303a, and FIG. 4B indicates the content of discarded region start information 303b. The lengths in the conveyance direction of the continuous sheet 110 for recording the discarded region start information 303a and 303b (hereinafter, when there is no need to distinguish between the two, they may be simply referred to as discarded region start information 303) are both 0.2 m.

The discarded region start information 303 includes recording information and discarded region information (waste paper information). The recording information includes information related to recorded pages and in-progress page, and the discarded region information includes information related to a discarded region start position (waste paper start position) and a length to discarded region end (waste paper end).

The "recorded pages" is information on a portion that has been recorded, in the image data to be recorded by the recording section 205 at the time when the splice 302a was detected. The "in-progress page" is information on a portion where recording was suspended in response to detection of the splice 302a in the image data to be recorded by the recording section 205. The "discarded region start position" is information on a start position (leading edge position) of the discarded region 305a in the conveyance direction. The "length to discarded region end" is information on the length of the discarded region 305a in the conveyance direction.

Since the page number of a deliverable to be subjected to the post-process work following the discarded region can be obtained from the recording information, the information of the page number can be utilized when the method of instructing the conveying part that the continuous sheet 110 in the post-process device is to specify the page number. On the other hand, since the length to a deliverable to be subjected to the post-process work following the discarded region can be obtained from the discarded region information, the information of the length can be utilized when the method of instructing the conveying part that the continuous sheet 110 in the post-process device is to specify the length. The details of the values of the discarded region start information 303a and 303b will be described later.

FIG. 4C indicates the content of discarded region end information 304a, and FIG. 4D indicates the content of discarded region end information 304b. The lengths in the conveyance direction of the continuous sheet 110 for recording the discarded region end information 304a and 304b (hereinafter, when there is no need to distinguish between the two, they may be simply referred to as discarded region end information 304) are both 0.2 m.

The discarded region end information 304 includes recording information and discarded region information. The recording information includes information related to a recording resumed page, and the discarded region information includes information related to a discarded region end position (waste paper end position) and a length from discarded region start (waste paper start).

The "recording resumed page" is information on a portion where recording suspended in response to detection of the splice 302a was resumed, in the image data to be recorded by the recording section 205. The "discarded region end position" is information on an end position (trailing edge position) of the discarded region 305a in the conveyance direction. The "length from discarded region start" is information on the length of the discarded region 305a in the conveyance direction.

Information on the deliverable resumed following the discarded region can be obtained from the recording information and the discarded region information. Since the start position of the discarded region can be also obtained, the length of the discarded region in which the continuous sheet 110 is conveyed can be obtained even when a post-process starts from the trailing edge of the continuous sheet 110. The details of the values of the discarded region end information 304a and 304b will be described later.

FIG. 4E indicates the content of discarded region statistical information 306. The length of the continuous sheet 110 for recording the discarded region statistical information 306 in the conveyance direction is 0.4 m.

The discarded region statistical information 306 includes control statistical information, relevant job management statistical information, and relevant substrate management statistical information. The control statistical information includes information related to the number of discarded region locations (number of waste paper locations) and recording results. The relevant job management statistical information includes a total conveyance length of the relevant jobs, a deliverable total length, and a discarded region total length (waste paper total length). The relevant substrate management statistical information includes a cumulative discarded region rate (cumulative waste paper rate) of the relevant substrate. The relevant substrate management statistical information also includes change information of the discarded region rate (waste paper rate), including discarded region rates for the latest 0 m or more and less than 1000 m, the previous 1000 m or more and less than 2000 m, and the even previous 2000 m or more and less than 3000 m.

From the control statistical information, the number and position of discarded region locations and the locations of successful deliveries can be obtained. This gives the whole picture of which portions will be subjected to post-process work and which portions will not. From the relevant job management statistical information, the length of the continuous sheet 110 consumed by recorded jobs and the discarded region rate can be obtained, and the recording efficiency of the relevant jobs can be obtained. Since the cumulative discarded region rate of the substrate used this time and the historical discarded region rates can be obtained from the relevant substrate management statistical information, the relevant substrate management statistical information can be utilized as an index of the quality of the continuous sheet 110. For example, if only the latest discarded region rate is abnormally large compared to the cumulative discarded region rate, it is possible that the quality of the roll paper currently being used is poor. The details of the values of the discarded region statistical information 306 will be described later.

The content of the discarded region start information 303a corresponding to the example of FIG. 3G will now be described. The "recorded pages" is the first two pages of a total of six pages. The "in-progress page" is the third page. The "discarded region start position" is 7.0 m, which is the sum of the length from the leading edge of the region of the continuous sheet 110 related to the recording of image data of six pages to the first page (5.0 m) and the length of two pages of images for which recording has been completed (1.0 m x 2 = 2.0 m). The "length to discarded region end" is 10.6 m, which is the sum of the length of a portion of the third page where recording was suspended (0.6 m) and a predetermined conveyance amount (10.0 m). The predetermined conveyance amount is a conveyance amount required for the splice 302a to reach the paper discharge apparatus 117. In the case of the recording system 100 of the first embodiment, it is the length of the conveyance path from the splice detector 107 to the paper discharge apparatus 117 (10.0 m).

The content of the discarded region end information 304a corresponding to the example of FIG. 3G will now be described. The "recording resumed page" is the third page, which is a page next to the second page for which recording has been completed. The "discarded region end position" is 17.6 m, which is the sum of the "discarded region start position" (7.0 m) and the "length to discarded region end" (10.6 m) in the discarded region start information 303a. The "length from discarded region start" is 10.6 m, which is the same as the "length to discarded region end" in the discarded region start information 303a.

The content of the discarded region start information 303b corresponding to the example of FIG. 3G will now be described. The "recorded pages" is the first five pages of a total of six pages. The "in-progress page" is the sixth page. The "discarded region start position" is 20.6 m, which is an addition of the end position of the discarded region 305a ("discarded region end position" in the discarded region end information 304a) (17.6 m) and the length of three pages (3.0 m) with 1 m per page image. The "length to discarded region end" is 10.4 m, which is the sum of the length of a portion, of the sixth page where recording was suspended, where recording has been performed before the recording suspension (0.4 m) and a predetermined conveyance amount (10.0 m).

The content of the discarded region end information 304b corresponding to the example of FIG. 3G will now be described. The "recording resumed page" is the sixth page, which is a page next to the fifth page for which recording has been completed. The "discarded region end position" is 31.0 m, which is the sum of the "discarded region start position" (20.6 m) and the "length to discarded region end" (10.4 m) in the discarded region start information 303b. The "length from discarded region start" is 10.4 m, which is the same as the "length to discarded region end" in the discarded region start information 303b.

The content of the discarded region statistical information 306 corresponding to the example of FIG. 3G will now be described. The "number of discarded region locations" in the "control statistical information" is two, which is the same as the number of times the discarded region start information 303 was created. The lengths and the page information in the "recording results" are clear from the above-described results, which are of the successful first six pages. The "trailing edge margin" is 32.0 to 37.0 m, since one page of an image with a length of 1.0 m is recorded from the end position of the discarded region 305b ("discard region end position" in the discarded region end information 304b) (31.0 m). The trailing edge margin includes the discarded region statistical information 306.

The "total conveyance length" in the "relevant job management statistical information" is the length of the continuous sheet 110 consumed by the relevant jobs, which is 37.0 m as in the control statistical information. The value in parentheses on the right is a percentage to the total conveyance length of the jobs, which is 100% for the total conveyance length. The "deliverable total length" is the sum of the length in the conveyance direction of the pages for which recording has been completed successfully without being suspended, which is 1.0 m x 6 = 6.0 m (16.2%). The "discarded region total length" is 21.0 m (56.8%), which is the sum of the length of the discarded region 305a (10.6 m) and the length of the discarded region 305b (10.4 m). The sum of the "deliverable total length" and the "discarded region total length" is 10.0 m less than the "total conveyance length" due to a leading edge margin of 5.0 m and a trailing edge margin of 5.0 m.

The "relevant substrate management statistical information" is a value based on historical recording results. The control section 202 accumulates a recording history for each roll model number in the storage section 201 every time recording is performed. The recording history stores the recording date and time and the relevant job management statistical information in association with each other. Since the storage section 201 has a limited capacity, the data to be stored in association with the recording date and time is for up to the latest 3000 m, and data before that is discarded. The cumulative value is stored separately without being associated with the recording date and time. This mechanism allows the control section 202 to calculate the cumulative discarded region rate. In the example of FIG. 4E, the "cumulative discarded region rate" is 5.0%. Similarly, the discarded region rate for the latest 0 m or more and less than 1000 m is 5.0%, the discarded region rate for the latest 1000 m or more and less than 2000 m is 4.9%, and the discarded region rate information for the latest 2000 m or more and less than 3000 m has no data. This shows that the current roll conveyance result is less than 2000 m, and the discarded region rate is stable.

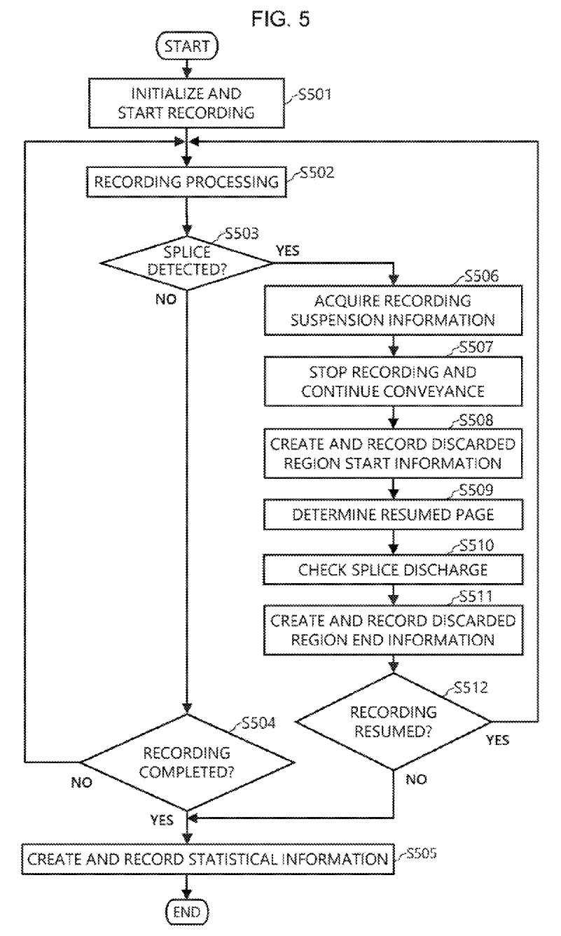

FIG. 5 is a flowchart illustrating a control of the recording system 100. In response to receiving a job, the control section 202 executes processing of this flowchart. The processing of this flowchart is executed under instructions from the control section 202, mainly via the storage section 201, the recording section 205, the conveying section 207, the detection section 212, and the operation display 102.

The storage section 201 stores, as specification information for the recording system 100, information on the predetermined conveyance amount (the length of the conveyance path from the splice detector 107 to the paper discharge apparatus 117) (10.0 m) and the discarded region start information 303. The storage section 201 also stores information on a conveyance length (0.2 m) required to record the discarded region end information 304, information on the leading edge margin length (5.0 m), and information on the trailing edge margin length (5.0 m).

The storage section 201 includes a recorded page counter, an in-progress page counter, a discarded region location counter (waste paper location counter), a final deliverable conveyance length counter, and a splice-detected conveyance length counter. The recorded page counter and the in-progress page counter store page numbers, and the discarded region location counter stores the number of detected splices. The final deliverable conveyance length counter stores the conveyance length of the continuous sheet 110 up to the time when recording of a page unit, which is an independent unit as a deliverable, is completed. The splice-detected conveyance length counter stores the conveyance length of the continuous sheet 110 up to the time when the splice 302 is detected. The storage section 201 further includes a relevant job total conveyance length counter, a relevant job deliverable total length counter, and a relevant job discarded region total length counter, which are source data for the relevant job management statistical information. Each of these counters for the relevant jobs stores the length of a conveyed continuous sheet 110, the length of a deliverable, and the length of a discarded region, and stores these in association with date information such that they can be utilized as source data for the relevant substrate management statistical information. The storage section 201 further includes a relevant substrate total conveyance length counter, a relevant substrate deliverable total length counter, and a relevant substrate discarded region total length counter, which are to be utilized as source data for the cumulative discarded region rate of the relevant substrate management statistical information. These counters for the relevant substrate management information are prepared for each substrate model number, and each stores the length of a conveyed continuous sheet 110, the length of a deliverable, and the length of a discarded region.

The storage section 201 also includes an automatic resuming flag (its initial value is "resume") that switches whether or not recording is to be automatically resumed after the discarded region end. Every time conveyance is performed, the control section 202 increments the relevant job total conveyance length counter and the relevant substrate total conveyance length counter. Furthermore, every time recording is performed, the control section 202 increments the relevant job deliverable total length counter and the relevant substrate deliverable total length counter.

In step S501, the control section 202 performs processing for initialization and of starting recording. The control section 202 resets to zero the recorded page counter, in-process page counter, discarded region location counter, relevant job total conveyance length counter, relevant job deliverable total length counter, and relevant job discarded region total length counter, which are provided in the storage section 201. The control section 202 resets to zero the final deliverable conveyance length counter and the splice-detected conveyance length counter. The control section 202 does not reset the total conveyance length counter, the deliverable total length counter, and the discarded region total length counter for each substrate. When completing resetting the counters, the control section 202 then identifies a substrate to be used for recording and a recording start page based on received job data, causes the conveying section 207 to convey a continuous sheet 110 by a leading edge margin, and then executes step S502.

In step S502, the control section 202 performs recording processing. The control section 202 causes the conveying section 207 to convey the continuous sheet 110, and causes the recording section 205 to record images on the continuous sheet 110 in order starting from the image of the recording start page. As the progresses of conveyance and recording, the control section 202 increments the conveyance length counter, the recorded page counter, and the final deliverable conveyance length counter. When completing the processing of this step, the control section 202 then executes step S503.

In step S503, the control section 202 checks whether or not a splice-detected ON signal has been received from the detection section 212. If the splice-detected ON signal has been received, the control section 202 executes step S506, and otherwise, the control section 202 executes step S504.

In step S504, the control section 202 determines whether or not the recording has been completed. If the recording is not completed, the control section 202 executes step S502 to continue the recording, and otherwise, the control section 202 executes step S505.

In step S505, the control section 202 creates and records statistical information. The control section 202 acquires the discarded region location counter stored in the storage section 201. If the value of the discarded region location counter is 1 or more, the control section 202 acquires the values of the various counters and creates discarded region statistical information 306. The control section 202 causes the recording section 205 to record the discarded region statistical information 306 on the continuous sheet 110. The control section 202 collects and calculates values of the control statistical information, the relevant job management statistical information, and the relevant substrate management statistical information, based on information described below in step S508. If the discarded region location counter is less than 1, the control section 202 determines that the job does not have a discarded region, and does not record the discarded region statistical information 306. Thereafter, the control section 202 causes the conveying section 207 to convey the continuous sheet 110 by a trailing edge margin, and then the processing is completed.

In step S506, the control section 202 acquires information related to recording suspension. The control section 202 acquires the recorded page counter and the in-progress page counter from the storage section 201, increments the discarded region location counter by 1, and then executes step S507.

In step S507, the control section 202 causes the recording section 205 to stop the recording of the relevant job, but continues the conveyance. The control section 202 stores the relevant job conveyance counter at this time in the splice-detected conveyance length counter in the storage section 201, and then executes step S508.

In step S508, the control section 202 creates and records discarded region start information 303. The control section 202 acquires the counter values from the storage section 201 to create discarded region start information 303, and causes the recording section 205 to record the discarded region start information 303 on the continuous sheet 110. The control section 202 generates a value for "recorded pages" in the discarded region start information 303 from the recorded page counter, and generates a value for "in-progress page" from the in-progress page counter. The control section 202 calculates a value for "discarded region start position" from the leading edge margin length (5 m), the number of recorded pages, and the page length. The control section 202 calculates a "length to discarded region end" as the sum of the length of the conveyance path from the splice detector 107 to the paper discharge apparatus 117 (10 m) and the conveyance length of the in-progress page. The control section 202 calculates a conveyance length of the in-process page from the splice detection conveyance length counter and the final deliverable conveyance length counter. In order to generate the discarded region statistical information 306, the control section 202 temporarily stores information generated for the discarded region start information 303 in the storage section 201 until the processing of the relevant job is completed. The information generated for the discarded region start information 303 includes information on a recorded page, an in-progress page, a discarded region start position, and a length to discarded region end. The control section 202 further increments the relevant substrate total conveyance length counter, the relevant substrate total deliverable length counter, and the relevant substrate total discarded region length counter as appropriate according to the substrate model number. After recording the discarded region start information 303, the control section 202 stops ejecting ink, and then executes step S509 while continuing the conveyance.

In step S509, the control section 202 determines a page for which the recording is to be resumed. The control section 202 acquires the recorded page counter from the storage section 201, determines the next page as the resumed page, and then executes step S510. At this time, the control section 202 performs control to continue the conveyance.

In step S510, the control section 202 checks whether the splice has reached the paper discharge apparatus 117. The control section 202 acquires from the storage section 201 the length of the conveyance path from the splice detector 107 to the paper discharge apparatus 117 (10.0 m) and the splice-detected conveyance length counter, and defines their sum as a recording resuming reference conveyance length. The control section 202 further acquires from the storage section 201 the conveyance length (0.2 m) required to record the discarded region end information 304 and the relevant job total conveyance length counter, and defines their sum as a discarded region conveyance length (waste paper conveyance length). At this point, the recording resuming reference conveyance length is greater than the discarded region conveyance length, but as time passes, the relevant job total conveyance length counter increases, and accordingly the discarded region conveyance length will eventually become equal to or greater than the recording resuming reference conveyance length. When the control section 202 detects that the discarded region conveyance length has become equal to or greater than the recording resuming reference conveyance length, the control section 202 determines that the splice 302 has reached the paper discharge apparatus 117, and then executes step S511. As described above, at this point the splice is actually located right before the paper discharge apparatus 117 by the length (0.2 m) in the conveyance direction required to record the discarded region end information 304, and reaches the paper discharge apparatus 117 when the recording of the discarded region end information 304 is completed in step S511.

In step S511, the control section 202 creates and records discarded region end information 304. The control section 202 acquires the counter values from the storage section 201 to create discarded region end information 304, and causes the recording section 205 to record the discarded region end information 304 on the continuous sheet 110. The control section 202 calculates a "recording resumed page" by adding one to the value of the recorded page counter. The control section 202 calculates a value for "discarded region end position" as the sum of the value of "discarded region start position" calculated in step S508 and the value of "length to discarded region end". By the control of step S510, when the recording of the discarded region end information 304 is completed, the splice 302 has reached the paper discharge apparatus 117, and therefore the recording of a deliverable can be resumed. The control section 202 completes this processing and then executes step S512.

In step S512, the control section 202 determines whether to resume the recording. The control section 202 acquires the value of the recording automatic resuming flag from the storage section 201. The value of the recording automatic resuming flag can be changed by the user via the operation display 102. If the value of the recording automatic resuming flag is "resume", the control section 202 executes step S502 and resumes the recording from the recording resumed page determined in step S509. If the value of the recording automatic resuming flag is "not resume", the control section 202 executes step S505. For "not resume", the control section 202 generates discarded region statistical information based on the information up to that point. For example, if the recording ends in the state illustrated in FIG. 3G, the control statistical information will be as follows:

Number of discarded region locations: 2

Recording Results

Leading Edge Margin: 0 to 5.0 m

Successful Pages: 1 to 2

Discarded Region 1: 7.0 to 17.6 m

An example of post-process work will now be described. The continuous sheet 110 is passed to the post-process in the state illustrated in FIG. 3G, and then an operator uses a post-process device to perform post-process work from the beginning of the continuous sheet 110 illustrated in FIG. 3G. If the operator carries out post-process work from the first page without knowing that information related to a discarded region has been recorded on the continuous sheet 110, the operator will visually recognize the discarded region start information 303a. The operator reads the "length to discarded region end" indicated in the discarded region start information 303a, and specifies a length of work to be skipped to the post-process device. When the post-process device skips the specified length, the discarded region 305a is skipped, then allowing the operator to resume the post-process work from the third page. Similarly, the operator visually recognizes the discarded region start information 303b, skips the discarded region 305b, resumes the post-process work from the sixth page, and then finishes the post-process work.

According to the recording method in the recording system 100 of the first embodiment, on a continuous sheet on which a plurality of pages of deliverables are recorded in a dispersed manner across discarded regions with splices present, information related to the discarded regions are recorded. Therefore, information necessary for a post-process, such as the position and length of the discarded region, can be transmitted to an offline post-process device not connected to the recording system 100 and an operator in the post-process. This can contribute to improving the efficiency of post-process work.

[Second Embodiment] In the recording system 100 of the first embodiment, when a splice is detected during recording, the control section 202 causes the recording section 205 to record information related to a discarded region (discarded region start information 303, discarded region end information 304, discarded region statistical information 306) on the continuous sheet 110 in the form of characters. In a recording system 100 of a second embodiment, when a splice is detected during recording, a control section 202 causes a recording section 205 to record information related to a discarded region on a continuous sheet 110 in the form of a code image such as a barcode. The recording of the information related to a discarded region on the continuous sheet 110 in the form of a barcode enables a post-process device equipped with a barcode reader to read the barcode to acquire information necessary for the post-process, such as the position and length of the discarded region. Thus, it is possible to transmit information necessary for the post-process to an offline post-process device that is not connected to the recording system 100. The code image is not limited to a barcode. The information to be coded can be, but is not limited to, for example, a string that conveys only a numerical value (the numbers to the right of the colon (:) in the text in FIGS. 4A to 4E).

[Third Embodiment] In the recording systems 100 of the first and second embodiments, when a splice is detected during recording, the control section 202 causes the recording section 205 to record information related to a discarded region on the continuous sheet 110 in the form of characters or a code image. In a recording system 100 of a third embodiment, when a splice is detected during recording, a control section 202 controls a communication section 206 to transmit information related to a discarded region to an external device. An example of the external device is a management information system (MIS). By notifying the MIS of the discarded region statistical information, the MIS can determine the work efficiency and cost of the relevant job from the discarded region rate of the relevant job. It is also possible to determine whether the work efficiency and cost of the relevant job are significantly lower or higher than historical results based on the cumulative discarded region rate of the relevant substrate. In addition, by understanding changes in the discarded region rate of the relevant substrate from discarded region rates for a specific period in the past, it is possible to know opportunities to request improvements in the substrate quality or to consider switching to another substrate.

[Fourth Embodiment] In the first embodiment, an example has been described in which the control statistical information of the discarded region statistical information 306 is written in the order in which the recording results are recorded on the continuous sheet 110. However, the recording results may be written in the reverse of the order in which they are recorded on the continuous sheet 110. In a case where a roll 125 wound up in a paper discharge apparatus 117 after recording is directly loaded into a post-process device, discarded region statistical information 306 is located at the beginning of the continuous sheet unwound from the roll 125 set in the post-process device. Therefore, by recording the recording results in the discarded region statistical information 306 in the reverse order of recording, page information of deliverables and information on discarded regions are recorded in the order in which an operator works in the post-process, thereby improving the efficiency of work. In the example of FIG. 3G, the description of "recording results" in the control statistical information of the discarded region statistical information 306 is as follows:

Leading Edge Margin: 0 to 5.0 m,

Successful Pages: 6

Discarded Region 1: 6.0 to 16.4 m

Successful Pages: 5 to 3

Discarded Region 2: 19.4 to 30.0 m

Successful Pages: 2 to 1

Trailing Edge Margin: 32.0 to 37.0 m

### [Fifth Embodiment]

In the first embodiment, an example has been described in which the control section 202 ends the recording when the value of the automatic resuming flag is "not resume" in step S512. However, the present disclosure is not limited to this. Specifically, when the value of the automatic resuming flag is "not resume", the control section 202 may control the operation display 102 to ask the user surely not to resume. This allows the recording to be automatically resumed even if the user unintentionally fails to set the automatic resuming flag to "resume."

### [Sixth Embodiment]

The recording system 100 of the first embodiment has been described that uses a method of ejecting ink onto the continuous sheet 110 as the image recording method in the first recording apparatus 103 and the second recording apparatus 104. However, the present disclosure is not limited to this. The present disclosure is applicable to even an electrophotographic method or another recording method as the image recording method in the first recording apparatus 103 and the second recording apparatus 104.

According to the present disclosure, it is possible to transmit information on a post-process to a post-process device or an operator in the post-process.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196515, filed November 11, 2024, which is hereby incorporated by reference herein in its entirety.

What is claimed is:

1. A recording apparatus comprising:
a conveying part configured to convey a continuous sheet in a conveyance direction;
a recording part configured to perform recording on the continuous sheet during the conveyance of the continuous sheet by the conveying part;
a detection part configured to detect a splice that is a connecting portion of the continuous sheet; and
a control part configured to control the recording part and the conveying part based on a detection result from the detection part,
wherein:
in a case where the detection part detects the splice during the recording by the recording part, the control part performs control to record, on the continuous sheet, information related to a discarded region that is a region of the continuous sheet, the region including the detected splice and not used as a deliverable; and
the information related to the discarded region includes at least one of:
in image data being recorded by the recording part,
information on a portion that has been recorded;
information on a portion where the recording has been suspended in response to the detection of the splice; and
information on a portion where the recording has been resumed after the suspension in response to the detection of the splice.

2. The recording apparatus according to claim 1, wherein, in a case where the detection part detects the splice during the recording by the recording part, the control part performs control to cause the conveying part to continue the conveyance of the continuous sheet, and suspend the recording of the image data being recorded by the recording part.

3. The recording apparatus according to claim 1, wherein the information related to the discarded region includes at least one of:
information on a start position of the discarded region in the conveyance direction;
information on an end position of the discarded region in the conveyance direction; and
information on a length of the discarded region in the conveyance direction.

4. The recording apparatus according to claim 1, wherein the control part performs control to record the information related to the discarded region on a leading edge portion of the discarded region in the conveyance direction.

5. The recording apparatus according to claim 1, wherein the control part performs control to record the information related to the discarded region on a trailing edge portion of the discarded region in the conveyance direction.

6. The recording apparatus according to claim 1, wherein the control part performs control to record the information related to the discarded region on the continuous sheet in form of characters.

7. The recording apparatus according to claim 1, wherein the control part performs control to record the information related to the discarded region on the continuous sheet in form of a code image.

8. The recording apparatus according to claim 2, wherein the control part performs control to:
after suspending the recording of the image data, record the information related to the discarded region on the continuous sheet; and
after recording the information related to the discarded region on the continuous sheet, stop the recording by the recording part.

9. The recording apparatus according to claim 2, wherein the control part performs control to:
after suspending the recording of the image data, cause the conveying part to convey the continuous sheet by a predetermined conveyance amount; and
after the conveying part has conveyed the continuous sheet by the predetermined conveyance amount, cause the conveying part to continue the conveyance of the continuous sheet, and resume the recording of the image data.

10. The recording apparatus according to claim 9, wherein the control part performs control to:
after the conveying part has conveyed the continuous sheet by the predetermined conveyance amount, record the information related to the discarded region on the continuous sheet; and
after recording the information related to the discarded region on the continuous sheet, resume the recording of the image data.

11. The recording apparatus according to claim 9, the recording apparatus further comprising:
a paper feed part configured to feed the continuous sheet to the recording part from a roll formed by winding the continuous sheet in a roll shape; and
a paper discharge part configured to wind up the continuous sheet having been conveyed through the recording part, into a roll shape,
wherein:
the detection part detects the splice upstream of the recording part in the conveyance direction; and
the predetermined conveyance amount is determined based on a conveyance amount required for the splice detected by the detection part to reach the paper discharge part.

12. The recording apparatus according to claim 11, wherein, in a case where the detection part detects the splice during the recording by the recording part, the control part performs control to record, on the continuous sheet, statistical information about the discarded region that has been formed in the roll.

13. The recording apparatus according to claim 12, wherein, after the recording of the image data by the recording part has been completed, the control part performs control to record the statistical information on the continuous sheet.

14. The recording apparatus according to claim 12, wherein the statistical information includes at least one of:
information on a length of the continuous sheet that has been conveyed during a period from start to end of the recording of the image data by the recording part;
information on a length of the continuous sheet on which the image data has been recorded;
information on a length of the discarded region that has been formed during the period; and
information on a cumulative length of the discarded region that has been formed so far in the roll.

15. The recording apparatus according to claim 1, the recording apparatus further comprising:
a communication part configured to communicate with an external device,
wherein the control part performs control to cause the communication part to transmit the information related to the discarded region to the external device.

16. A recording apparatus comprising:
a conveying part configured to convey a continuous sheet in a conveyance direction;
a recording part configured to perform recording on the continuous sheet during the conveyance of the continuous sheet by the conveying part;
a detection part configured to detect a splice that is a connecting portion of the continuous sheet;
a communication part configured to communicate with an external device; and
a control part configured to control the communication part based on a detection result from the detection part,
wherein:
in a case where the detection part detects the splice during the recording by the recording part, the control part performs control to cause the communication part to transmit information related to a discarded region that is a region of the continuous sheet, the region including the detected splice and not used as a deliverable; and
the information related to the discarded region includes at least one of:
in image data being recorded by the recording part,
information on a portion that has been recorded;
information on a portion where the recording has been suspended in response to the detection of the splice; and
information on a portion where the recording has been resumed after the suspension in response to the detection of the splice.

17. A recording method for recording an image on a continuous sheet, the recording method comprising the steps of:
detecting a splice that is a connecting portion of the continuous sheet; and
recording, in a case where the splice is detected during the recording of the image, on the continuous sheet, information related to a discarded region that is a region of the continuous sheet, the region including the detected splice and not used as a deliverable,
wherein the information related to the discarded region includes at least one of:
in image data being recorded by the recording part,
information on a portion that has been recorded;
information on a portion where the recording has been suspended in response to the detection of the splice; and
information on a portion where the recording has been resumed after the suspension in response to the detection of the splice.

18. A computer-readable storage medium storing:
a program for causing a computer to execute each step of a recording method for recording an image on a continuous sheet,
wherein:
the recording method comprising the steps of:
detecting a splice that is a connecting portion of the continuous sheet; and
recording, in a case where the splice is detected during the recording of the image, on the continuous sheet, information related to a discarded region that is a region of the continuous sheet, the region including the detected splice and not used as a deliverable; and
the information related to the discarded region includes at least one of:
in image data being recorded by the recording part,
information on a portion that has been recorded;
information on a portion where the recording has been suspended in response to the detection of the splice; and
information on a portion where the recording has been resumed after the suspension in response to the detection of the splice.
